(19) United States
(12) Patent Application Publication
(10) Pub. No.: US 2026/0119302 A1
(43) Pub. Date: Apr. 30, 2026

(54) PLASMA STATUS MONITORING USING AN ARTIFICIAL INTELLIGENCE MODEL

(71) Applicant: Applied Materials, Inc., Santa Clara, CA (US)

(72) Inventors: Rui Dai, San Jose, CA (US); Bosong Sun, Santa Clara, CA (US); Xin Luo, Palo Alto, CA (US); Min Shen, Livermore, CA (US)

(21) Appl. No.: 19/192,796

(22) Filed: Apr. 29, 2025

Related U.S. Application Data
(60) Provisional application No. 63/712,375, filed on Oct. 25, 2024.

(51) Int. Cl. G06F 11/07

(52) U.S. Cl. CPC G06F 11/079; G06F 11/0781

(57) ABSTRACT

A system comprising a memory device and a processing device, operatively coupled with the memory device, to perform operations. The processing device receives a measured output of a sensor, wherein the measured output corresponds to a plasma signal from a processing chamber. The processing device filters the measured output of the sensor to obtain a filtered output. The processing device compares the filtered output with an expected output to determine an error value associated with the filtered output, wherein the expected output is generated using a first artificial intelligence (AI) model. The processing device determines whether the error value satisfies an error threshold criterion. The processing device identifies, based on whether the error value satisfies the error threshold criterion, a transition.

### RELATED APPLICATIONS

This application claims the benefit of U.S. Provisional Patent Application No. 63/712,375 filed Oct. 25, 2024, entitled “Plasma Status Monitoring using an Artificial Intelligence Model” which is incorporated by reference herein.

### BACKGROUND

The plasma etch process is a method used in semiconductor fabrication to selectively remove materials from a substrate through the interaction of reactive plasma species with a target material in a processing chamber. This selective material removal enables the creation of patterns in a substrate, allowing for, in some implementations, the functioning of semiconductors. The three main phases of the plasma etch process-passivation, etching, and pump-out-require precise timing and monitoring to ensure that the material is removed (e.g., etched) exactly as intended. Detecting when each phase starts and ends (e.g., a plasma phase transition) ensures that the desired results are achieved.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In one aspect of the disclosure, a method includes receiving a measured output of a sensor. The measured output corresponds to a plasma signal originating from a processing chamber in which the sensor is located. The method further includes filtering the received measured output of the sensor. Filtering the received measurement output involves removing the “noise” present in the output. Noise, in the context of sensor data, refers to any unwanted or random variation in an output that obscures or interferes with the actual information being measured. The method further includes generating an expected output using a first AI model. In some embodiments, the first AI model is a convolutional neural network. The filtered output is compared to the expected output to determine an error value associated with the filtered output. The method further includes determining whether the error value satisfies an error threshold criterion. In some embodiments, the error threshold criterion is a maximum acceptable error value distinguishing the difference between the filtered output and the expected output. The method further includes identifying, based on whether the error value satisfies the error threshold criterion, a transition in the processing chamber.

In another aspect of the disclosure, the method includes training the first AI model. The method further includes providing training input data to the AI model. The training input data includes historical sensor data. The target output includes error values associated with respective historical sensor data.

In another aspect of the disclosure, the method further includes, responsive to determining that the error value fails to satisfy the error threshold criterion, obtaining, using a second AI model, root cause data indicating a root cause associated with the error value. The method further includes logging the root cause data.

In another aspect of the disclosure, the method includes training the second AI model. The method further includes providing training input data to the AI model. The training input data includes historical error values. The target output includes root causes associated with the historical error values.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system (exemplary system architecture), according to certain embodiments.

FIG. 2 is a flow diagram describing a method of plasma status monitoring in accordance with some embodiments of the present disclosure.

FIG. 3A is a top schematic view of an example manufacturing system, according to aspects of the present disclosure.

FIG. 3B illustrates a top schematic view of a processing chamber of an example manufacturing system, in accordance with some embodiments of the present disclosure.

FIG. 3C illustrates a side schematic view of a processing chamber of an example manufacturing system, in accordance with some embodiments of the present disclosure.

FIG. 4 depicts an example filtration process applied to the measured output of one or more sensors to generate a filtered output, in accordance with some embodiments of the present disclosure.

FIG. 5 depicts a metadata table comprising process entries, in accordance with some embodiments of the present disclosure.

FIG. 6 depicts a block diagram of an illustrative computer system operating in accordance with embodiments of the present disclosure.

### DETAILED DESCRIPTION

Described herein are technologies directed to plasma status monitoring using an artificial intelligence (AI) model. Manufacturing equipment is used to produce substrates, such as semiconductor wafers. The properties of these substrates are controlled by the conditions under which the substrates were processed. Accurate knowledge of the status in the manufacturing chamber during operation (e.g., phase transitions), are important to producing the expected output.

The plasma etch process is a method used in semiconductor fabrication to selectively remove materials from a substrate through the interaction of reactive plasma species with the target material. This selective material removal enables the creation of patterns in a substrate, which can allow for the functioning of semiconductors. The plasma etch process typically includes three main phases: Passivation, Etch, and Pump-Out. Phase one, the passivation phase may involve the deposition of material between spacers to create a protective layer, which defines the etching boundaries and prevents unwanted material removal. In phase two, the etch phase, the process may actively remove the target materials using reactive plasma species to achieve the desired patterns in the semiconductor substrate. Phase three, the pump-out, may evacuate the etch byproducts from the chamber for subsequent processes.

The three main phases—passivation, etching, and pump-out—require precise timing and monitoring to ensure that the material is removed (e.g., etched) exactly as intended. Detecting when each phase starts and ends (e.g., a plasma phase transition) ensures that the desired results are achieved. For example, in the etching phase, if the transition from the passivation phase or to the pump-out phase is not accurately identified, it could lead to over-etching (removal of too much material) or under-etching (insufficient material removal). Over-etching can damage underlying layers, while under-etching can leave unwanted material, both of which degrade device performance. In the passivation phase, proper deposition between spacers is crucial to prevent unwanted etching in certain areas. If the transition to the etch phase is poorly timed, this protective layer may be compromised, affecting the precision of the etching process.

Current plasma pattern identification methods rely heavily on sensors (such as optical frequency sensors (OFS)) to directly analyze plasma patterns (e.g., phase transitions). However, these sensors usually suffer from limitations related to sensor quality and the constraints imposed by their installation locations within the etching chamber. As such, the output may be affected by signal disturbances such as spikes and noise, which can compromise the accuracy of the detection signals. Noise, in the context of sensor data, refers to any unwanted or random variation in an output that obscures or interferes with the actual information being measured. It is essentially an unwanted disturbance that degrades the quality of the output and can originate from various internal or external sources. The disturbances from signal spikes and noise mean that conventional plasma status monitoring techniques struggle to consistently identify stable peaks, making it difficult to accurately identify phase transitions. Furthermore, the inaccuracy of conventional plasma monitoring techniques necessitates the manual identification of phase transitions to distinguish them from noisy data. This results in a process that is both time-consuming and labor-intensive, thereby reducing overall process efficiency and introducing unnecessary delays.

Aspects of the present disclosure address the above and other deficiencies by providing a method to improve plasma status monitoring within a processing chamber using one or more AI models in conjunction with filtered sensor data.

In one aspect of the disclosure, a method includes receiving a measured output of a sensor. The output corresponds to a plasma signal from the processing chamber in which the sensor is located. In its current state, the measured output is vulnerable to noise and other environmental disturbances. The method further includes filtering the received measured output of the sensor to remove any unwanted noise or other disturbances present. The method further includes generating an expected output using an AI model. In some embodiments, the AI model is a U-net convolutional neural network that is trained using training input data that includes historical sensor data, and target output data that includes error values associated with respective historical sensor data. The generated expected output is compared to the filtered output to determine an error value associated with the filtered output. This error value can be represented by a variance percentage between the expected output and the filtered output. The method further includes determining whether the error value satisfies an error threshold criterion. In some embodiments, the error threshold criterion is a maximum acceptable error value distinguishing the difference between the filtered output and the expected output. Based on whether the error value satisfies the error threshold criterion, the data can be deemed reliable enough such that a transition can be accurately identified in the sensor output.

In another aspect of the disclosure, the method further includes, in response to determining that the error value fails to satisfy the error threshold criterion, obtaining root cause data indicating a root cause associated with the error value, and logging the root cause data. This root cause data is generated using a second AI model. In some embodiments, the second AI model is a neural network reservoir. In some embodiments, the second AI model is trained using training input data that includes historical error values, system conditions, and target output data that includes root causes associated with the historical error values. The output of the NNR (Neural Network Reservoir) can be further input to one layer of ANN (Artificial Neural Network) to facilitate further classification.

Aspects of the present disclosure result in technological advantages over conventional methods, which often suffer from signal disturbances and processing delays. Aspects of the present disclosure enhance reliability for phase transition identification by filtering sensor data to eliminate noise and utilizing an AI model to address unreliable measured sensor outputs that can affect the accurate identification of phase transitions. In addition, an AI model can be used to identify additional factors that are affecting the output. This combination enhances accuracy and reliability and enables real-time monitoring of the plasma status. Furthermore, aspects of the present disclosure increase processing throughput (as compared to conventional methods) by circumventing the need to rely on manual identification of phase transitions to ensure the necessary accuracy of detection signals.

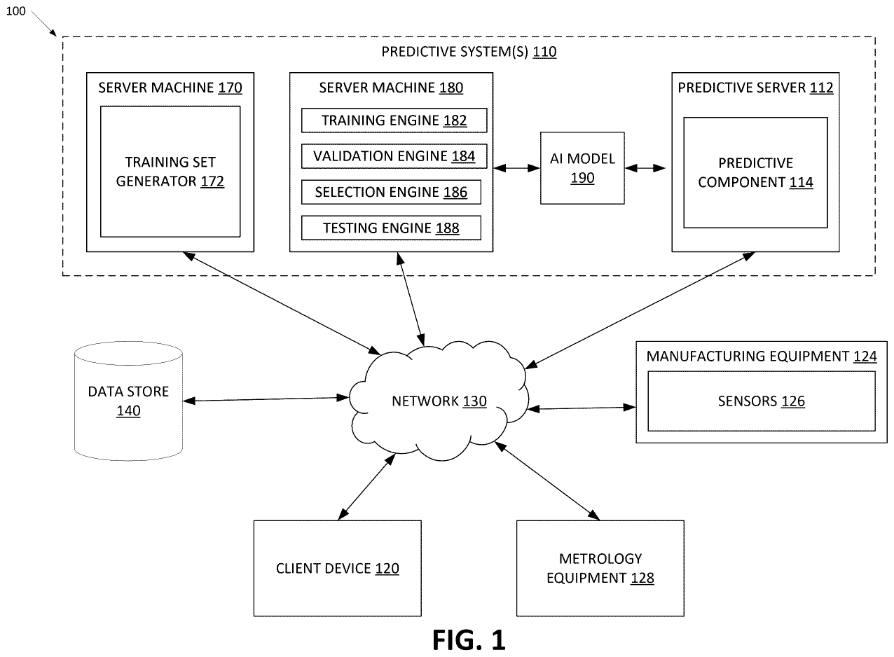

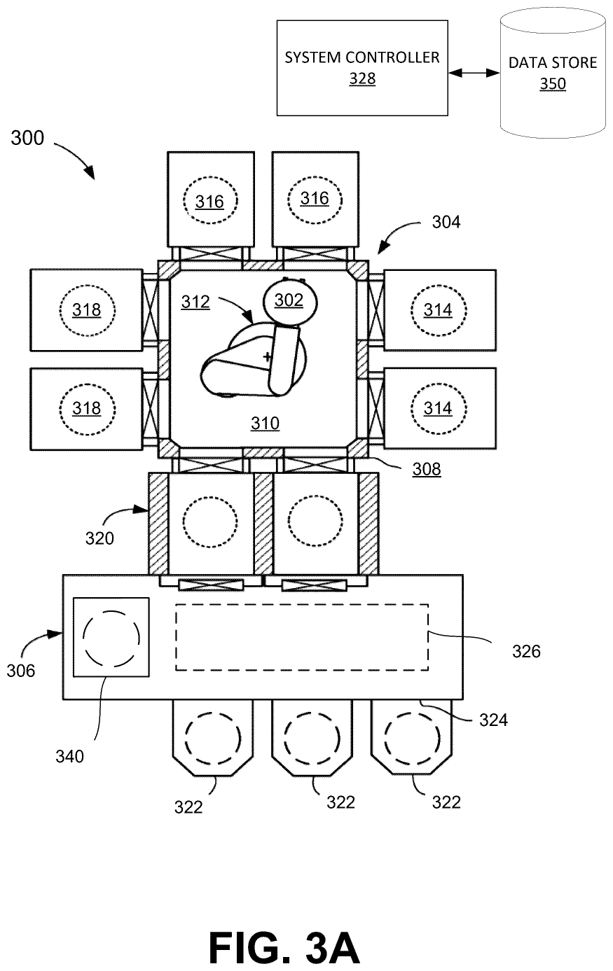

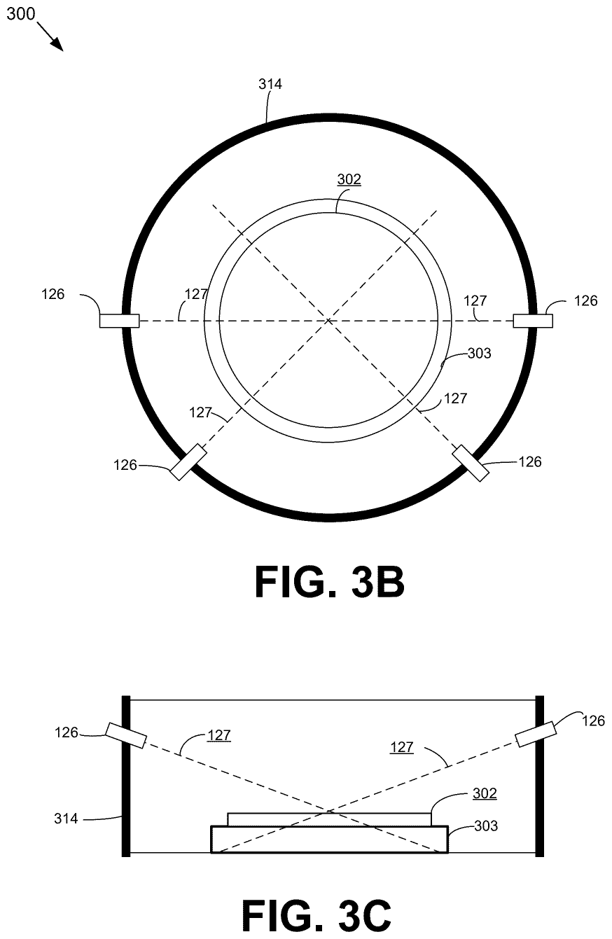

FIG. 1 depicts an illustrative computer system architecture 100, according to aspects of the present disclosure. In some embodiments, computer system architecture 100 may be included as part of a manufacturing system for processing substrates, such as manufacturing system 300 of FIG. 3A. Computer system architecture 100 includes a client device 120, manufacturing equipment 124, metrology equipment 128, a predictive server 112 (e.g., to generate predictive data, to provide model adaptation, to use a knowledge base, etc.), and a data store 140. The predictive server 112 may be part of a predictive system 110. The predictive system 110 may further include server machines 170 and 180. The manufacturing equipment 124 may include sensors 125 configured to capture data for a substrate being processed at the manufacturing system. In some embodiments, the manufacturing equipment 124 and sensors 126 may be part of a sensor system that includes a sensor server (e.g., field service server (FSS) at a manufacturing facility) and sensor identifier reader (e.g., front opening unified pod (FOUP) radio frequency identification (RFID) reader for sensor system). In some embodiments, metrology equipment 128 may be part of a metrology system that includes a metrology server (e.g., a metrology database, metrology folders, etc.) and metrology identifier reader (e.g., FOUP RFID reader for metrology system).

Manufacturing equipment 124 may be responsible to produce products following either a recipe or performing runs over a certain time frame. Manufacturing equipment 124 may include a substrate measurement subsystem that includes one or more sensors 126 configured to generate spectral data and/or positional data for a substrate embedded within the substrate measurement subsystem. Sensors 126 that are configured to generate spectral data (herein referred to as spectra sensing components) may include optical frequency sensors, reflectometry sensors, ellipsometry sensors, thermal spectra sensors, capacitive sensors, and so forth. In some embodiments, spectra sensing components may be included within the substrate measurement subsystem or another portion of the manufacturing system. One or more sensors 126 (e.g., eddy current sensors, etc.) may also be configured to generate non-spectral data for the substrate. Further details regarding manufacturing equipment 124 and the substrate measurement subsystem are provided with respect to FIG. 3A.

In some embodiments, sensors 126 may provide sensor data associated with manufacturing equipment 124. Sensor data may include a value of one or more of temperature (e.g., heater temperature), spacing (SP), pressure, high frequency radio frequency (HFRF), voltage of electrostatic chuck (ESC), electrical current, flow, power, voltage, etc. Sensor data may be associated with or indicative of manufacturing parameters such as hardware parameters, such as settings or components (e.g., size, type, etc.) of the manufacturing equipment 124, or process parameters of the manufacturing equipment 124. The sensor data may be provided while the manufacturing equipment 124 is performing manufacturing processes (e.g., equipment readings when processing products). The sensor data 142 may be different for each substrate.

Metrology equipment 128 can provide metrology data associated with substrates (e.g., wafers, etc.) processed by manufacturing equipment 124. The metrology data may include a value of one or more of film property data (e.g., wafer spatial film properties), dimensions (e.g., thickness, height, etc.), dielectric constant, dopant concentration, density, defects, etc. In some embodiments, the metrology data may further include a value of one or more surface profile property data (e.g., an etch rate, an etch rate uniformity, a critical dimension of one or more features included on a surface of the substrate, a critical dimension uniformity across the surface of the substrate, an edge placement error, etc.). The metrology data may be of a finished or semi-finished product. The metrology data may be different for each substrate. Metrology data can be generated using, for example, reflectometry techniques, ellipsometry techniques, TEM techniques, and so forth.

In some embodiments, metrology equipment 128 can be included as part of the manufacturing equipment 124. For example, metrology equipment 128 can be included inside of or coupled to a process chamber and configured to generate metrology data for a substrate before, during, and/or after a process (e.g., a deposition process, an etch process, etc.) while the substrate remains in the process chamber. In such instances, metrology equipment 128 can be referred to as in-situ metrology equipment. In another example, metrology equipment 128 can be coupled to another station of manufacturing equipment 124. For example, metrology equipment can be coupled to a transfer chamber, such as transfer chamber 310 of FIG. 3, a load lock, such as load lock 320, or a factory interface, such as factory interface 306. In such instances, metrology equipment 128 can be referred to as integrated metrology equipment. In other or similar embodiments, metrology equipment 128 is not coupled to a station of manufacturing equipment 124. In such instances, metrology equipment 128 can be referred to as inline metrology equipment or external metrology equipment. In some embodiments, integrated metrology equipment and/or inline metrology equipment are configured to generate metrology data for a substrate before and/or after a process.

The client device 120 my include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. Each client device 120 may include an operating system connected that allows users (e.g., via a Graphical User Interface (GUI) displayed via the client device 120) to one or more of generate, view, or edit data (e.g., indication associated with manufacturing equipment 124, corrective actions associated with manufacturing equipment 124, etc.).

Data store 140 may be a memory (e.g., random access memory), a drive (e.g., a hard drive, a flash drive), a database system, or another type of component or device capable of storing data. Data store 140 may include multiple storage components (e.g., multiple drives or multiple databases) that may span multiple computing devices (e.g., multiple server computers). The data store 140 may store spectral data, non-spectral data, metrology data, and predictive data. Spectral data may include historical spectral data (e.g., spectral data generated for a previous substrate processed at the manufacturing system) and/or current spectra (spectral data generated for a current substrate being processed at the manufacturing system. Current spectral data may be data for which predictive data is generated. Although embodiments of the present disclosure reference spectral data for training a machine learning model, it should be noted that embodiments of the present disclosure can also include non-spectral data used to train the machine learning model. In some embodiments, metrology data can include historical metrology data (e.g., metrology measurement values for a prior substrate processed at the manufacturing system). The data store 140 may also store contextual data associated with a substrate being processed at the manufacturing system (e.g., recipe name, recipe step number, preventive maintenance indicator, operator, etc.).

In some embodiments, data store 140 may be configured to store data that is not accessible to a user of the manufacturing system. For example, spectral data, non-spectral data, and/or positional data obtained for a substrate being processed at the manufacturing system may not be accessible to a user of the manufacturing system. In some embodiments, all data stored at data store 140 may be inaccessible by a user (e.g., an operator) of the manufacturing system. In other or similar embodiments, a portion of data stored at data store 140 may be inaccessible by the user while another portion of data stored at data store 140 may be accessible by the user. In some embodiments, one or more portions of data stored at data store 140 may be encrypted using an encryption mechanism that is unknown to the user (e.g., data is encrypted using a private encryption key). In other or similar embodiments, data store 140 may include multiple data stores where data that is inaccessible to the user is stored in one or more first data stores and data that is accessible to the user is stored in one or more second data stores.

In some embodiments, predictive system 110 includes server machine 170 and server machine 180. Server machine 170 includes a training set generator 172 that is capable of generating training data sets (e.g., a set of data inputs and a set of target outputs) to train, validate, and/or test an (AI) model 190. In some embodiments, the data set generator 172 may partition the training data into a training set, a validating set, and a testing set. In some embodiments, the predictive system 110 generates multiple sets of training data.

In some embodiments, the illustrative computer system architecture 100 comprises multiple examples of predictive system 110, each associated with an AI model 190; and the predictive system 110 associated with each AI model 190 comprises a distinct server machine 170, server machine 180, AI model 190, predictive server 112, and the respective sub-components (e.g., such as predictive component 114). For example, in an embodiment that uses two AI models, the computer system architecture 100 can include two predictive systems 110, each associated with one AI model 190. Further detail is provided below.

Server machine 180 may include a training engine 182, a validation engine 184, a selection engine 185, and/or a testing engine 186. An engine may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. Training engine 182 may be capable of training an AI model 190. The AI model 190 may refer to the model artifact that is created by the training engine 182 using the training data that includes training inputs and corresponding target outputs (correct answers for respective training inputs). The training engine 182 may find patterns in the training data that map the training input to the target output (the answer to be predicted), and provide the AI model 190 that captures these patterns. The AI model 190 may use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), etc.

The validation engine 184 may be capable of validating a trained AI model 190 using a corresponding set of features of a validation set from training set generator 172. The validation engine 184 may determine an accuracy of each of the trained machine learning models 190 based on the corresponding sets of features of the validation set. The validation engine 184 may discard a trained AI model 190 that has an accuracy that does not meet a threshold accuracy. In some embodiments, the selection engine 185 may be capable of selecting a trained AI model 190 that has an accuracy that meets a threshold accuracy. In some embodiments, the selection engine 185 may be capable of selecting the trained AI model 190 that has the highest accuracy of the trained machine learning models 190.

The testing engine 186 may be capable of testing a trained AI model 190 using a corresponding set of features of a testing set from data set generator 172. For example, a first trained AI model 190 that was trained using a first set of features of the training set may be tested using the first set of features of the testing set. The testing engine 186 may determine a trained AI model 190 that has the highest accuracy of all of the trained machine learning models based on the testing sets.

Predictive server 112 includes a predictive component 114 that is responsible for managing and executing the AI model 190. The predictive component processes input data using a trained AI model 190 to generate one or more outputs. The generated one or more outputs can be used as input to re-train AI model 190. This is explained in further detail below.

The client device 120, manufacturing equipment 124, sensors 126, metrology equipment 128, predictive server 112, data store 140, server machine 170, and server machine 180 may be coupled to each other via a network 130. In some embodiments, network 130 is a public network that provides client device 120 with access to predictive server 112, data store 140, and other publicly available computing devices. In some embodiments, network 130 is a private network that provides client device 120 access to manufacturing equipment 124, metrology equipment 128, data store 140, and other privately available computing devices. Network 130 may include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

It should be noted that in some other implementations, the functions of server machines 170 and 180, as well as predictive server 112, may be provided by a fewer number of machines. For example, in some embodiments, server machines 170 and 180 may be integrated into a single machine, while in some other or similar embodiments, server machines 170 and 180, as well as predictive server 112, may be integrated into a single machine.

In general, functions described in one implementation as being performed by server machine 170, server machine 180, and/or predictive server 112 can also be performed on client device 120. In addition, the functionality attributed to a particular component can be performed by different or multiple components operating together.

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

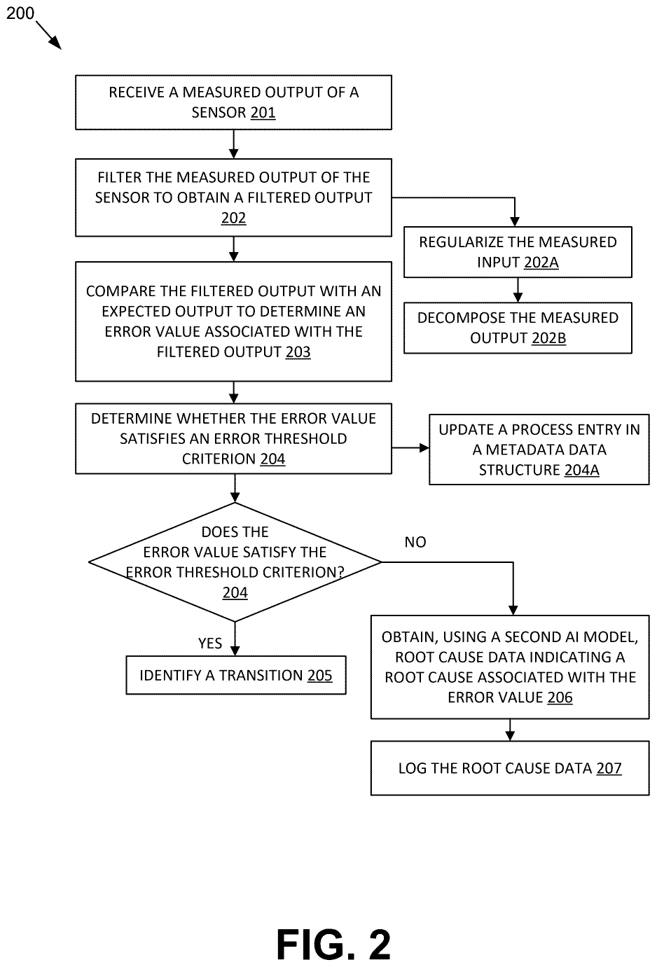

FIG. 2 is a flow diagram describing a method of plasma status monitoring in accordance with some embodiments of the present disclosure. Method 200 is performed by processing logic that may include hardware (circuitry, dedicated logic, etc.), software (such as is run on a general purpose computer system or a dedicated machine), firmware, or some combination thereof. In one implementation, method 200 may be performed by a computer system, such as computer system architecture 100 of FIG. 1. In other or similar implementations, one or more operations of method 200 may be performed by one or more other machines not depicted in the figures. In some aspects, one or more operations of method 200 may be performed by predictive component 114 of server machine 112.

For simplicity of explanation, the methods are depicted and described as a series of acts. However, acts in accordance with this disclosure may occur in various orders and/or concurrently, and with other acts not presented and described herein. Furthermore, not all illustrated acts may be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

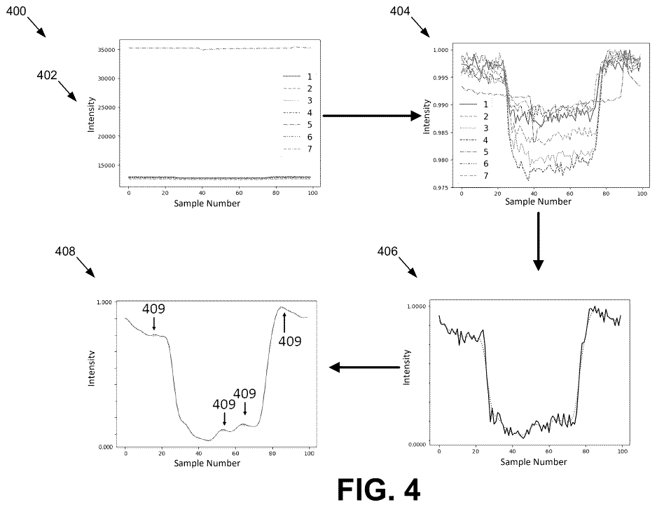

At operation 210, the processing logic receives a measured output of a sensor (e.g., sensor 126 of FIG. 1). In some embodiments the sensor is an optical frequency sensor. In some embodiments, the measured output is a spectral waveform, plotting light intensity versus sample number, where the sample number corresponds to different optical frequencies. As will be discussed in more detail below, waveform 402 of FIG. 4 illustrates an example of a measured output from a number of optical frequency sensors.

An optical frequency sensor is a type of sensor that uses optical fibers to detect changes in environmental conditions, such as temperature, pressure, strain, or chemical composition. As the plasma undergoes phase transitions—such as from passivation to etching—the energy levels of ions and electrons shift, leading to changes in the frequencies of emitted photons. The optical frequency sensor detects these changes by capturing the emitted photons and generating spectral waveforms as a measured output, which are plots of light intensity versus optical frequency.

These spectra exhibit distinct peaks corresponding to specific atomic or molecular transitions in the plasma. Shifts in peak positions or variations in their intensities indicate plasma phase transitions, fluctuations in plasma density, or changes in temperature. The sensor works by transmitting light through the optical fiber, and any variations in the environment cause changes in the light's properties, such as its intensity, phase, wavelength, or polarization.

At operation 202, the processing logic filters the measured output of the sensor to obtain a filtered output. FIG. 4 depicts an example filtration process 400 applied to a measured output of one or more sensors 126 to generate a filtered output, in accordance with some embodiments of the present disclosure. This example filtration process is also known as “wavelet filtering.” As described previously, waveform 402 of FIG. 4 illustrates an example of a measured output from a number of optical frequency sensors. In this example embodiment, the measured output is a waveform plotting light intensity versus sample number, where the “sample number” corresponds to different optical frequencies. The example waveform 402 comprises seven different sensor outputs numbered in the legend 1-7. Some of the sensor outputs are outliers relative to each other in terms of amplitude, and so the scale on the y-axis obscures the peaks that denote phase transition points, among other sensor outputs.

In some embodiments, filtering the measured output of the sensor to obtain a filtered output comprises, at operation 202A, regularizing the measured output. Regularization may involve normalizing the data. Waveform 404 of FIG. 4 illustrates an example of a measured output that has undergone regularization. Normalizing data in the context of a waveform refers to adjusting the amplitude of the waveform so that the data fits within a specific range, typically to make different datasets comparable or to improve the numerical properties for further processing. The goal is to standardize the scale of the waveform, while maintaining its overall shape and characteristics.

Returning to FIG. 2, at operation 202B, to filter the measured output, the processing logic decomposes the measured output. Waveform 406 of FIG. 4 illustrates an example of a measured output that has undergone decomposition. Decomposition (e.g., wavelet decomposition) works by imposing threshold constraints, penalizing large deviations that are more likely to be noise or instability rather than actual signal variations, eliminating noise while retaining significant sensor output components. Specifically, the processing logic can decompose the regularized output, separating the output into approximation coefficients (representing low-frequency, smooth features) and detail coefficients (capturing high-frequency components, often associated with noise). Plasma signals often comprise both high-frequency noise and low-frequency fundamental vibrations. In some embodiments, the processing logic decomposes the measured output by applying a low-pass filter to retain signals below a designated threshold corresponding to the sensors 126. For example, when using an OFS sensor (e.g., sensor 126) that is sensitive to signals above 10 kHz, the low-pass filter captures the low-frequency modulations corresponding to large-scale, coherent plasma dynamics. Conversely, the processing logic can also apply a high-pass filter to isolate signals above 10 kHz up to the sensor's upper bandwidth limit, capturing high-frequency modulations such as turbulence-induced fluctuations and high-energy plasma interactions.

Once the signal is decomposed, thresholding can be applied to the detail coefficients to remove noise. In some embodiments, the processing logic implements hard thresholding, which sets all coefficients below a threshold to zero. In some embodiments, the processing logic implements soft thresholding, which reduces the magnitude of coefficients by the threshold value. Waveform 408 of FIG. 4 illustrates an example of a filtered output. The transition points 409 are emphasized in waveform 408.

Returning to FIG. 2, at operation 203, the processing logic compares the filtered output with an expected output to determine an error value associated with the filtered output. In some embodiments, the expected output is generated using a first AI model that receives the filtered output as input and provides the expected output as an output.

In some embodiments, the first AI model (e.g., an AI model 190) comprises a U-net convolutional neural network (U-net CNN). The present disclosure is not limited to a U-net CNN; other suitable AI models, such as but not limited to fully convolutional networks (FCNs) and recurrent neural networks (RNNs), can also be employed as the first AI model. In some embodiments implementing a U-net CNN as the first AI model 190, the one-dimensional vector data from the filtered output is transformed into a two-dimensional matrix. The resulting matrix represents the waveform data in a format suitable for convolutional operations, enabling the AI model to learn spatial features that correspond to frequency patterns in the original measured output. The symmetry of the U-net architecture can cause it to have a shape that resembles the letter “U.” As such, the model can be referred to as a u-shaped model architecture, u-shaped neural network (U-net), other term, or a combination thereof. The U-net CNN comprises two main parts: the contracting path (encoder) and the expansive path (decoder). The contracting path is responsible for capturing the context and features of the input data by progressively down-sampling the input (e.g., reducing the spatial dimensions of the input matrix) through convolutional and pooling layers. Each convolutional layer uses a set of learnable filters to extract local patterns and create “feature maps.” Pooling layers reduce the spatial dimensions of the data, allowing the network to learn hierarchical features at multiple scales.

At the bottom of the “U”, the bottleneck layer connects the contracting and expansive paths. This layer captures the most abstract representation of the input data, containing high-level features that are crucial for accurate reconstruction in the subsequent layers. The expansive path then reconstructs the spatial dimensions by up-sampling the feature maps using transposed convolutional layers (also known as deconvolutional layers). These layers increase the spatial resolution of the feature maps, effectively reversing the down-sampling performed in the contracting path.

Skip connections between corresponding layers in the contracting and expansive paths concatenate feature maps from the contracting path directly to the expansive path, ensuring that high-resolution features lost during down-sampling are preserved. This mechanism allows the network to utilize both the localized, fine-grained information and the broader contextual information necessary for accurate prediction (e.g., an expected output based on the input data).

In some embodiments, the first AI model is trained (e.g., by training engine 182 of server machine 180) using historical sensor data as training inputs and error values associated with respective historical sensor data as target outputs. In some embodiments, the filtered output and the error value associated with the filtered output can be used to retrain the first AI model.

At operation 204, the processing logic determines whether the error value satisfies an error threshold criterion. In some embodiments, the error threshold criterion comprises a maximum allowed error value resulting from a variation between the filtered output and the expected output. In some embodiments, the maximum allowed error value is predetermined. In certain embodiments, satisfying the error threshold criterion requires that the error value—representing the variation between the filtered output and the expected output—be less than or equal to the maximum allowed error value. The error value fails to satisfy the error threshold criterion when the error value—representing the variation between the filtered output and the expected output—exceeds the maximum allowed error value. In some embodiments, the maximum allowed error value is 3%. In an example that is in accordance with some embodiments of the present disclosure, if the difference between the filtered output and the expected output exceeds a 3% magnitude, the error value fails to satisfy the error threshold criterion.

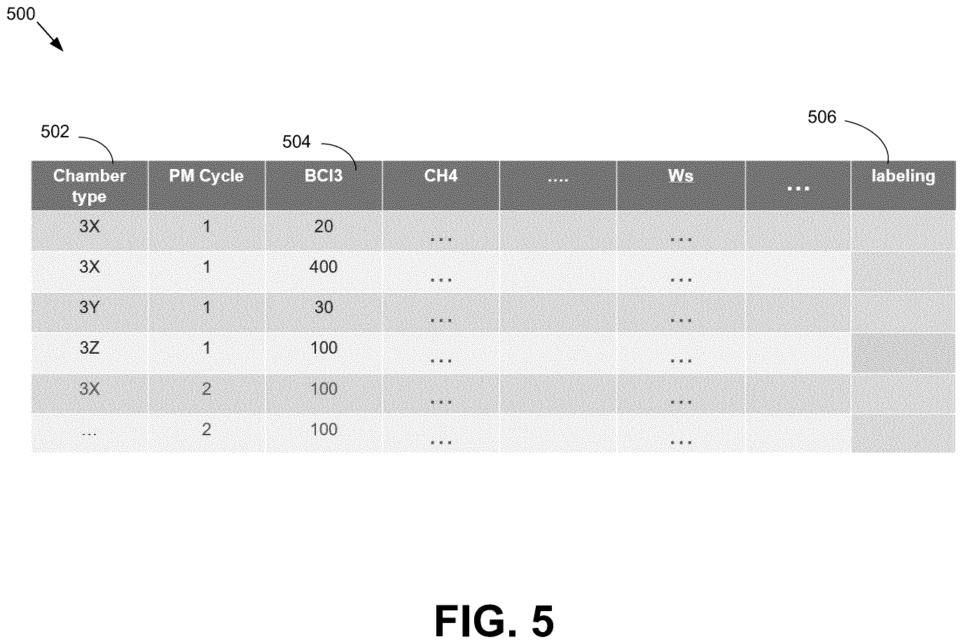

In some embodiments, at operation 204A, the processing logic updates a process entry in a metadata data structure. A metadata data structure may be a table, a database, a file, or any other data structure that includes multiple process entries, where each process entry comprises data corresponding to a measured output and an error value. In some embodiments, each process entry corresponds to a measured output from the sensors 126 gathered during the plasma etch process. The processing logic can initialize each process entry as part of a monitoring operation. FIG. 5 depicts an example metadata table comprising process entries, in accordance with some embodiments of the present disclosure. In some embodiments, the process entry includes chemical and hardware data related to the plasma etch process. For example, column 502 of FIG. 5 comprises hardware data related to the plasma etch process, and column 504 of FIG. 5 comprises chemical data related to the plasma etch process. In some embodiments, the process entry further includes a marker indicating whether the error value satisfies the error threshold criterion. For example, column 506 of FIG. 5 comprises marker data related to the plasma etch process. The metadata set data is utilized in the NNR model to gain insights into the causes of errors. The present disclosure is not limited to a metadata table; other suitable metadata data structures for storing data associated with the plasma etch process can also be implemented.

Returning to FIG. 2, responsive to determining the error value satisfies the error threshold criterion, at operation 205, the processing logic identifies a transition such as a phase transition in the filtered output corresponding to the measured output. In some embodiments, the first AI model provides the expected transition points of the plasma, which are then compared with the user input settings, specifically the error threshold. If the error value is within the error threshold, the processing logic uses the expected transition points from the first AI model as the current transition points in the current plasma etch process.

In some embodiments, responsive to determining that the error value fails to satisfy the error threshold criterion, at operation 206, the processing logic obtains, using a second AI model, root cause data indicating a root cause associated with the error value. In some embodiments, the error value is provided by the processing logic as an input to the second AI model to obtain an output indicating the root cause data. In some embodiments, root cause data includes processing chamber parameters, chemical data, and hardware data. Through the second AI model, the processing logic can classify the different factors or conditions in the processing chamber that are influencing the plasma etch process and resulting in the error value (e.g., the error value that fails to satisfy the error threshold criterion).

In some embodiments, the second AI model (e.g., an AI model 190) comprises a neural network reservoir (NNR). An NNR, also known as a reservoir computing model is a type of recurrent neural network (RNN) made up of non-linear nodes connected in a looping structure as echo state networks (ESNs) that offers a highly efficient framework for processing temporal inputs as a low training cost. Each node has a dynamic weight that is temporally adjusted as inputs are provided to the NNR. The interactions between the nodes in the reservoir result in the transformation of input data. The output is generated through these transformations as the input data passes over the weighted nodes. A subsequent single layer of ANN architecture can be attached for facilitating the diagnosis process.

In some embodiments, the second AI model is trained (e.g., by training engine 182 of server machine 180) using training input data comprising historical error values and target output data comprising root causes associated with the historical error values. In some embodiments, the second AI model can be retained using the filtered output, the root cause data associated with the filtered output, and an indication of accuracy of the root cause data (as provided by a user). The present disclosure is not limited to an NNR; other suitable AI models can also be employed as the second AI model.

At operation 207, the processing logic logs the root cause data. In some embodiments the processing logic logs the root cause data in a metadata data structure. In some embodiments, the processing logic presents the root cause data to the user through a graphical user interface via the client device 120.

FIG. 3A is a top schematic view of an example manufacturing system 300, according to aspects of the present disclosure. Manufacturing system 300 may perform one or more processes on a substrate 302. Substrate 302 may be any suitably rigid, fixed-dimension, planar article, such as, e.g., a silicon-containing disc or wafer, a patterned wafer, a glass plate, or the like, suitable for fabricating electronic devices or circuit components thereon.

Manufacturing system 300 may include a process tool 304 and a factory interface 306 coupled to process tool 304. Process tool 304 may include a housing 308 having a transfer chamber 310 therein. Transfer chamber 310 may include one or more processing chambers (also referred to as process chambers) 314, 316, 318 disposed therearound and coupled thereto. Processing chambers 314, 316, 318 may be coupled to transfer chamber 310 through respective ports, such as slit valves or the like. Transfer chamber 310 may also include a transfer chamber robot 312 configured to transfer substrate 302 between process chambers 314, 316, 318, load lock 320, etc. Transfer chamber robot 312 may include one or multiple arms where each arm includes one or more end effectors at the end of each arm. The end effector may be configured to handle particular objects, such as wafers.

Processing chambers 314, 316, 318 may be adapted to carry out any number of processes on substrates 302. A same or different substrate process may take place in each processing chamber 314, 316, 318. A substrate process may include atomic layer deposition (ALD), physical vapor deposition (PVD), chemical vapor deposition (CVD), etching, annealing, curing, pre-cleaning, metal or metal oxide removal, or the like. In some embodiments, a substrate process may include a combination of two or more of atomic layer deposition (ALD), physical vapor deposition (PVD), chemical vapor deposition (CVD), etching, annealing, curing, pre-cleaning, metal or metal oxide removal, or the like. Other processes may be carried out on substrates therein. Processing chambers 314, 316, 318 may each include one or more sensors 126 configured to capture data for substrate 302 and/or an environment within processing chamber 314, 316, 318, before, after, or during a substrate process. In some embodiments, the one or more sensors 126 may be configured to capture spectral data and/or non-spectral data for a portion of substrate 302. In some embodiments, a sensor of the one or more sensors is an optical frequency sensor.

FIG. 3B and FIG. 3C respectively illustrate a top schematic view and a side schematic view of a processing chamber 314 of an example manufacturing system 300, in accordance with some embodiments of the present disclosure. FIG. 3B is not limited to processing chamber 314 and can represent the structure of processing chambers 316 and 318 of FIG. 3A. Processing chamber 314 comprises sensors 126, each with an associated sensing region 127 directed at the substrate 302 resting upon a substrate pedestal 303. In some embodiments, the one or more sensors 126 of the processing chamber 314 comprises an optical frequency sensor (OFS). In some embodiments, the sensors 126 are mounted at axis symmetry locations on the processing chamber 314 to collect the photons emitted by excited plasma (an example of which is depicted in FIG. 3B).

A load lock 320 may also be coupled to housing 308 and transfer chamber 310. Load lock 320 may be configured to interface with, and be coupled to, transfer chamber 310 on one side and factory interface 306. Load lock 320 may have an environmentally-controlled atmosphere that may be changed from a vacuum environment (wherein substrates may be transferred to and from transfer chamber 310) to an inert-gas environment at or near atmospheric-pressure (wherein substrates may be transferred to and from factory interface 306) in some embodiments.

Factory interface 306 may be any suitable enclosure, such as, e.g., an Equipment Front End Module (EFEM). Factory interface 306 may be configured to receive substrates 302 from substrate carriers 322 (e.g., Front Opening Unified Pods (FOUPs)) docked at various load ports 324 of factory interface 306. A factory interface robot 326 (shown dotted) may be configured to transfer substrates 302 between substrate carriers (also referred to as containers) 322 and load lock 320. In other and/or similar embodiments, factory interface 306 may be configured to receive replacement parts from replacement parts storage containers 322.

Manufacturing system 300 may also be connected to a client device (not shown) that is configured to provide information regarding manufacturing system 300 to a user (e.g., an operator). In some embodiments, the client device may provide information to a user of manufacturing system 300 via one or more graphical user interfaces (GUIs). For example, the client device may provide information regarding one or more modifications to be made to a process recipe for a substrate 302 via a GUI.

Manufacturing system 300 may also include a system controller 328. System controller 328 may be and/or include a computing device such as a personal computer, a server computer, a programmable logic controller (PLC), a microcontroller, and so on. System controller 328 may include one or more processing devices, which may be general-purpose processing devices such as a microprocessor, central processing unit, or the like. More particularly, the processing device may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device may also be one or more special-purpose processing devices such as an application specific integrated circuit (ASIC), a field programmable gate array (FPGA), a digital signal processor (DSP), network processor, or the like. System controller 328 may include a data storage device (e.g., one or more disk drives and/or solid state drives), a main memory, a static memory, a network interface, and/or other components. System controller 328 may execute instructions to perform any one or more of the methodologies and/or embodiments described herein. In some embodiments, system controller 328 may execute instructions to perform one or more operations at manufacturing system 300 in accordance with a process recipe. The instructions may be stored on a computer readable storage medium, which may include the main memory, static memory, secondary storage and/or processing device (during execution of the instructions).

System controller 328 may receive data from sensors included on or within various portions of manufacturing system 300 (e.g., processing chambers 314, 316, 318, transfer chamber 310, load lock 320, etc.). Data received by the system controller 328 may include spectral data and/or non-spectral data for a portion of substrate 302. For purposes of the present description, system controller 328 is described as receiving data from sensors included within processing chambers 314, 316, 318. However, system controller 328 may receive data from any portion of manufacturing system 300 and may use data received from the portion in accordance with embodiments described herein. In an illustrative example, system controller 328 may receive spectral data from one or more sensors for processing chamber 314, 316, 318 before, after, or during a substrate process at the processing chamber 314, 316, 318. Data received from sensors of the various portions of manufacturing system 300 may be stored in a data store 350. Data store 350 may be included as a component within system controller 328 or may be a separate component from system controller 328. In some embodiments, data store 350 may be data store 140 described with respect to FIG. 1.

Manufacturing system 300 may further include a substrate measurement subsystem 340. Substrate measurement subsystem 340 may obtain spectra measurements for one or more portions of a substrate 302 before or after the substrate 302 is processed at manufacturing system 300. In some embodiments, substrate measurement subsystem 340 may obtain spectra measurements for one or more portions of substrate 302 in response to receiving a request for the spectra measurements from system controller 328. Substrate measurement subsystem 340 may be integrated within a portion of manufacturing system 300. In some embodiments, substrate measurement subsystem 340 may be integrated within factory interface 306. In other or similar embodiments, substrate measurement subsystem 340 may not be integrated with any portion of manufacturing system 300 and instead may be a stand-alone component. In such embodiments, a substrate 302 measured at substrate measurement subsystem 340 may be transferred to and from a portion of manufacturing system 300 prior to or after the substrate 302 is processed at manufacturing system 300.

Substrate measurement subsystem 340 may obtain spectra measurements for a portion of substrate 302 by generating spectral data and/or spectral for the portion of substrate 302. In some embodiments, substrate measurement subsystem 340 is configured to generate spectral data, non-spectral data, positional data, and other substrate property data for substrate 302 (e.g., a thickness of substrate 302, a width of substrate 302, etc.). After generating data for substrate 302, substrate measurement subsystem 340 may transmit the generated data to system controller 328. Responsive to receiving data from substrate measurement subsystem 340, system controller 328 may store the data at data store 350.

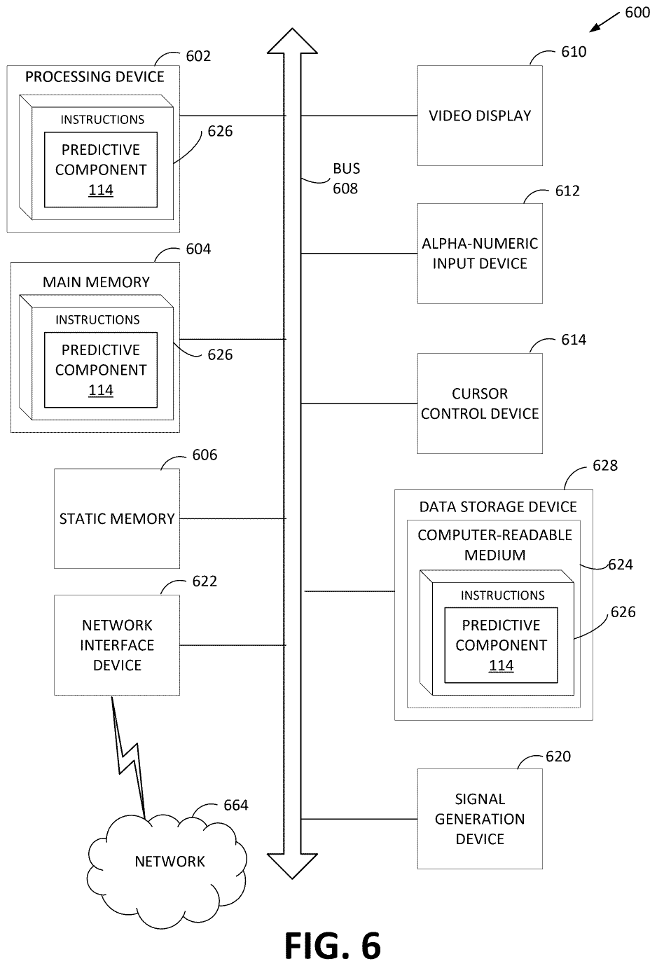

FIG. 6 depicts a block diagram of an illustrative computer system 600 operating in accordance with one or more aspects of the present disclosure. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In embodiments, computing device 600 may correspond to system controller 328 of FIG. 3A.

The example computing device 600 includes a processing device 602, a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a secondary memory (e.g., a data storage device 628), which communicate with each other via a bus 608.

Processing device 602 may represent one or more general-purpose processors such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 may also be or include a system on a chip (SoC), programmable logic controller (PLC), or other type of processing device. Processing device 602 is configured to execute the processing logic for performing operations and steps discussed herein.

The computing device 600 may further include a network interface device 622 for communicating with a network 664. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 628 may include a machine-readable storage medium (or more specifically a non-transitory computer-readable storage medium) 624 on which is stored one or more sets of instructions 626 embodying any one or more of the methodologies or functions described herein. Wherein a non-transitory storage medium refers to a storage medium other than a carrier wave. The instructions 626 may also reside, completely or at least partially, within the main memory 604 and/or within the processing device 602 during execution thereof by the computer device 600, the main memory 604 and the processing device 602 also constituting computer-readable storage media.

The computer-readable storage medium 624 may also be used to store model 190 and data used to train model 190. The computer readable storage medium 624 may also store a software library containing methods that use model 190. While the computer-readable storage medium 624 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “of” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system, comprising:
a memory device; and
a processing device, operatively coupled with the memory device, to perform operations comprising:
receiving a measured output of a sensor, wherein the measured output corresponds to a plasma signal from a processing chamber;
filtering the measured output of the sensor to obtain a filtered output;
comparing the filtered output with an expected output to determine an error value associated with the filtered output, wherein the expected output is generated using a first artificial intelligence (AI) model;
determining whether the error value satisfies an error threshold criterion; and
identifying, based on whether the error value satisfies the error threshold criterion, a transition.

2. The system of claim 1, wherein filtering the measured output of the sensor to obtain a filtered output comprises:
regularizing the measured output; and
decomposing the measured output.

3. The system of claim 1, wherein the sensor is an optical frequency sensor (OFS).

4. The system of claim 1, wherein the first AI model comprises a U-net convolutional neural network.

5. The system of claim 1, the operations further comprising:
training the first AI model using historical sensor data as training inputs and error values associated with respective historical sensor data as target outputs.

6. The system of claim 5, the operations further comprising:
re-training the first AI model using the filtered output and the error value associated with the filtered output.

7. The system of claim 1, wherein the error threshold criterion comprises a maximum allowed error value resulting from a variation between the filtered output and the expected output.

8. The system of claim 1, the operations further comprising:
updating a process entry in a metadata data structure, wherein the process entry comprises data corresponding to the measured output and the error value.

9. The system of claim 1, further comprising:
responsive to determining that the error value fails to satisfy the error threshold criterion:
obtaining, using a second AI model, root cause data indicating a root cause associated with the error value; and
logging the root cause data.

10. The system of claim 9, wherein the second AI model comprises a neural network reservoir.

11. The system of claim 9, the operations further comprising:
training the second AI model using training input data comprising historical error values and target output data comprising root cause data associated with the historical error values.

12. A method comprising:
receiving, by a processing device, a measured output of a sensor, wherein the measured output corresponds to a plasma signal from a processing chamber;
filtering the measured output of the sensor to obtain a filtered output;
comparing the filtered output with an expected output to determine an error value associated with the filtered output, wherein the expected output is generated using a first artificial intelligence (AI) model;
determining whether the error value satisfies an error threshold criterion; and
identifying, based on whether the error value satisfies the error threshold criterion, a transition.

13. The method of claim 12, wherein filtering the measured output of the sensor to obtain a filtered output comprises:
regularizing the measured output; and
decomposing the measured output.

14. The method of claim 12, wherein the first AI model comprises a U-net convolutional neural network.

15. The method of claim 12, wherein the error threshold criterion comprises a maximum allowed error value resulting from a variation between the filtered output and the expected output.

16. The method of claim 12, further comprising:
responsive to determining that the error value fails to satisfy the error threshold criterion:
obtaining, using a second AI model, root cause data indicating a root cause associated with the error value; and
logging the root cause data.

17. A non-transitory machine-readable storage medium comprising instructions that, when executed by a processing device, cause the processing device to perform operations comprising:
receiving a measured output of a sensor, wherein the measured output corresponds to a plasma signal from a processing chamber;
filtering the measured output of the sensor to obtain a filtered output;
comparing the filtered output with an expected output to determine an error value associated with the filtered output, wherein the expected output is generated using a first artificial intelligence (AI) model;
determining whether the error value satisfies an error threshold criterion; and
identifying, based on whether the error value satisfies the error threshold criterion, a transition.

18. The non-transitory machine-readable storage medium of claim 17, wherein the sensor is an optical frequency sensor (OFS).

19. The non-transitory machine-readable storage medium of claim 17, wherein the error threshold criterion comprises a maximum allowed error value resulting from a variation between the filtered output and the expected output.

20. The non-transitory machine-readable storage medium of claim 17, further comprising:
responsive to determining that the error value fails to satisfy the error threshold criterion:
obtaining, using a second AI model, root cause data indicating a root cause associated with the error value; and
logging the root cause data.
